(19) United States
(12) Patent Application Publication
(10) Pub. No.: US 2011/0154203 A1
(43) Pub. Date: Jun. 23, 2011

(54) Interactive Advertising Platform and Methods

(76) Inventors: Andrew Michael Spencer, Garden Grove, CA (US); Daniel John Spencer, Huntington Beach, CA (US); Scott Christian Reese, San Jose, CA (US)

(21) Appl. No.: 12/878,558

(22) Filed: Sep. 9, 2010

Related U.S. Application Data
(60) Provisional application No. 61/240,848, filed on Sep. 9, 2009.

(51) Int. Cl. G06F 3/01

(52) U.S. Cl. 715/719; 715/716

(57) ABSTRACT

A method of providing an entertaining and interactive interface for a user to view a displayable multimedia packet, comprises: obtaining a multimedia packet (“MMP”) relating to a product, service or provider, the MMP having a predesigned progression from beginning to end; obtaining or generating a series of queries relating to the product, service or provider; establishing a series of predetermined elapsed times, based on the MMP's predesigned progression, at which each of the various queries will be presented to the user; associating each of the various queries with one of the predetermined elapsed times; and placing the MMP and the queries into a format presentable to a user to allow the user to view the MMP along with the queries.

### PRIORITY CLAIM

This application claims benefit of copending U.S. Provisional Patent Application Ser. No. 61/240,848, filed Sep. 9, 2009, which is hereby incorporated herein by reference in its entirety.

### BACKGROUND

### Field of the Invention

The present invention relates generally to systems and methods for advertising services or products through multimedia interfaces. More particularly, the present invention relates to interactive advertising platforms and methods that utilize an entertaining game interface to present users with advertising content.

### SUMMARY OF THE INVENTION

In accordance with one aspect of the invention, an interactive advertisement multimedia platform is provided, including a multimedia packet (“MMP”) containing or presenting information relating to goods or services, the MMP having a predesigned progression from beginning to end. A display frame can be displayable on a display screen and the MMP can be displayed within the display frame. A series of queries can each be related to content of the MMP, the series of queries being presentable in the display frame at predetermined elapsed time intervals while the MMP is being displayed without disrupting the predesigned progression of the MMP. A data input field can be oriented within the display frame, the date input field allowing a user to present answers to the queries.

In accordance with another aspect of the invention, a method of providing an entertaining and interactive interface for a user to view a displayable multimedia packet is provided, including: obtaining a multimedia packet (“MMP”) relating to a product, service or provider, the MMP having a predesigned progression from beginning to end; obtaining or generating a series of queries relating to the product, service or provider; establishing a series of predetermined elapsed times, based on the MMP's predesigned progression, at which each of the various queries will be presented to the user; associating each of the various queries with one of the predetermined elapsed times; and placing the MMP and the queries into a format presentable to a user to allow the user to view the MMP along with the queries.

In accordance with another aspect of the invention, a method of providing an entertaining and interactive interface for a user to experience a displayable multimedia packet is provided, including: obtaining a multimedia packet (“MMP”) relating to a product, service or provider, the MMP having a predesigned progression; obtaining or generating a series of queries relating to the product, service or provider; establishing a series of predetermined elapsed times, based on the MMP's predesigned progression, at which each of the various queries will be presented to the user; associating each of the various queries with one of the predetermined elapsed times; displaying the MMP to the user; and concurrently displaying to the user, without disrupting the predesigned progression of the MMP, one or more of the queries at the predetermined elapsed time.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates an exemplary layout screen or display frame of an interactive advertisement multimedia platform in use with the present system;

FIG. 2 is a flowchart of an exemplary manner in which an MMP can be presented to a user;

FIG. 3 is a flowchart of an exemplary manner in which an advertisement campaign can be generated with the present invention; and

FIG. 4 is a flowchart of an exemplary manner in which advertisement campaigns generated in accordance with the present invention can be presented to ad unit players (clients) accessible by users.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinary skill in the relevant arts. It should also be understood that terminology employed herein is used for the purpose of describing particular embodiments only and is not intended to be limiting.

It must be noted that, as used in this specification and the appended claims, the singular forms “a” and “the” can include plural referents, unless the context clearly dictates otherwise. Thus, for example, reference to a “data input field” can include reference to one or more of such display screens.

### DEFINITIONS

In describing and claiming the present invention, the following terminology will be used in accordance with the definitions set forth below.

As used herein, the term “display screen” or “display” is used to refer to a display suitable for use in displaying a variety of types of multimedia packets to a consumer. Typically, such displays will be electronic in nature: exemplary displays include, without limitation, computer monitors, Personal Digital Assistant (“PDA”) screens, cell phone screens, televisions, notebook screens, kiosk screens, and the like. In many cases, the display screen or display can include an active feedback component that allows users to contact or otherwise select a specific area of the display to thereby input data to interact with the multimedia presentation being displayed on the display screen.

As used herein, the term “multimedia packet” or “MMP” is used to refer to a variety of types of data packets that can be presented to a viewer. Suitable packets can include, without limitation, video data, audio data, image file data, and combinations and collections thereof. Generally, an MMP will have a natural, predesigned elapsed time sequence: in other words, it is played from beginning to end with the MMP data presenting information consecutively through an elapsed time frame. Thus, such packets generally include a beginning and an end, and the intermediate portions of the packet are presented consistently therebetween. There is typically a natural sequence or story line to such MMPs, and thus a natural, intuitive flow to such packets that will be readily appreciated by most users. As a result, should such MMPs be played “out of order,” a user would inherently detect that the story line is disjointed, unintelligible or otherwise not correct.

While the MMPs referenced herein include such a predesigned elapsed time sequence, they can include more than one of such sequences that can be played as alternate story lines. For example, in some embodiments of the invention, the flow of the MMP is varied based upon the answers provided by a user to queries presented by the present advertising interface. While alternate or varying sequences of the same MMP are possible, each alternate sequence will still have a predesigned, natural progression.

As used herein, the term “hotspot” is to be understood to refer to an active portion of a display screen on which a user can mouse click, or contact with a stylus, finger or other device, or otherwise interface with, to provide feedback or answers while the MMP is being displayed. As one non-limiting example, an MMP might include a video in which a series of bubbles is being created by a child. The user can be prompted to “click on” as many bubbles as he or she can during a predetermined time period. The process by which the present invention creates a modified campaign MMP can include programming into the packet overlays upon all of the bubbles in the video so as to register a correct “click” on each bubble (e.g., hotspot). Typically, such overlays will need to be programmed into (or over) each frame of the video, and will “move” with the bubbles as the MMP progresses.

As used herein, the terms “query” and “prompt” are sometimes used interchangeably and are to be understood to refer to a variety of types of requests for input from a user. Examples of queries or prompts include, without limitation, questions for which definitive answers are available, presentation of hotspots with which the user can interact, prompts for information from the user, etc.

As used herein, the term “substantially” refers to the complete, or nearly complete, extent or degree of an action, characteristic, property, state, structure, item, or result. As an arbitrary example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As another arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

### INVENTION

In one aspect of the invention, an entertaining trivia/memory game is provided that utilizes audio/video advertisements in such a manner that users/players are encouraged to pay careful attention to short, sponsored multimedia clips (e.g., multimedia packets or “MMPs”) while viewing the MMP. The present invention does so by presenting the user with a series of queries or other input prompts and tracks the user's correct responses. In this manner, the user can be encouraged to earn a high “score” and be rewarded with discounts and the like for advertiser's products and services. The result is a versatile interactive advertising platform (IAP) that has a high level of engagement with its audience. Higher levels of engagement with target audiences are very much desirable by advertisers.

While the invention is not so limited, the following description will focus on embodiments of the invention in which the game play mechanics are executed in Flash version hosted on a website, corporate websites, across online advertising networks, etc. The systems and methods of the invention can also be readily adapted for use with handheld devices (e.g., PDAs (Personal Digital Assistants), cell phones, portable personal computers, etc.).

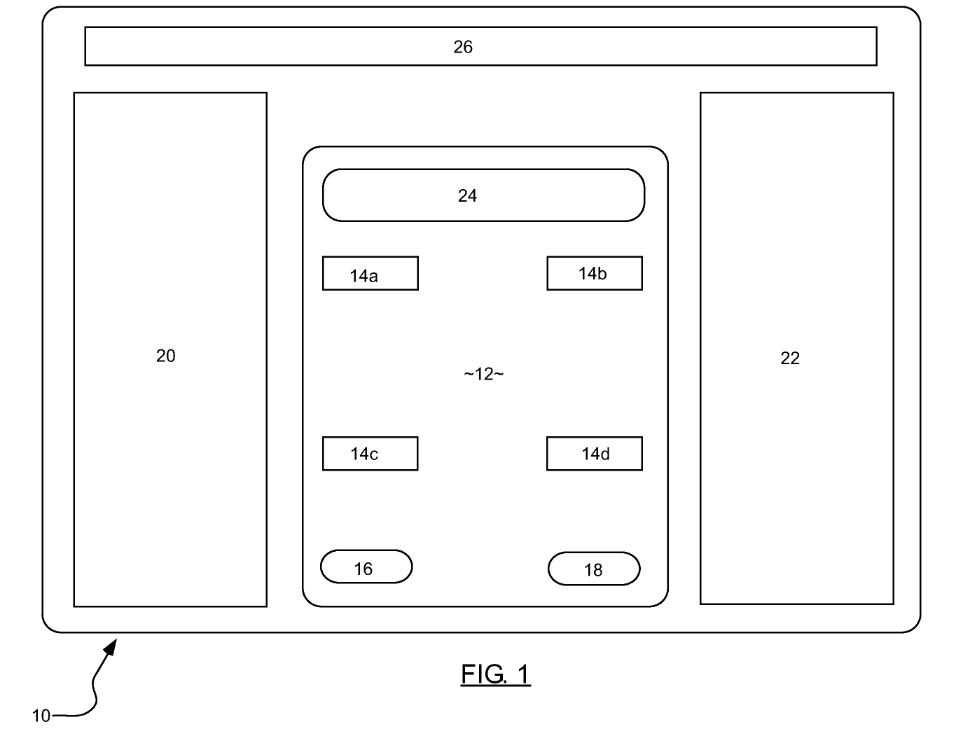

As shown generally in FIG. 1, in one embodiment of the invention the primary game play screen or frame 10 can be displayed on a variety of different types of display screens. Encompassed within the frame are a variety of features or data/input fields. As shown generally at 12, a multimedia packet (MMP) can be displayed (or played) as many such conventional packets are (e.g., the very common “video” played on numerous websites, in emails, etc.). Typically, the MMP includes an audio/video advertisement that has already been prepared that serves to advertise a company's goods and/or services. Generally speaking, the present platform plays the MMP from beginning to end without interrupting (e.g., pausing, stopping or otherwise disrupting the predesigned flow of the advertisement). The queries presented, data collected, and other advertisement presentation, hotspot presentation, etc., can all be accomplished while the MMP continues to progress.

The frame 10 can be displayed on a variety of known display screens, including, without limitation, personal computer display screens, laptop display screens, PDA screens, cell phone screens, kiosk screens, and the like.

Within the frame 10 a variety of query fields, and/or data input fields can be displayed. For example, field 24 can be query field in which a question that is related to the present MMP can be presented to the user. For example, if the MMP is related to an advertisement for an automobile, the query might be something of the sort “Which auto maker's car is being advertised.” Data input fields 14a, 14b, 14c, 14d, etc., can include possible responses to the query (e.g., “Ford,” “Audi,” etc.). A user can click or tap (depending upon the type of screen on which the frame is displayed) to input his or her answer. In some embodiments, the amount of time available for the user to answer the question can be limited. A time field 16 can display the amount of time remaining for the user to input an answer to the query.

Once the user answers the query, another query can be presented in a similar fashion. Typically, the queries will be related to a time period that has elapsed since the MMP began. For example, a query related to a topic introduced late into the MMP story line will not be presented to a user until after that portion of the MMP has been played. Multiple queries can be associated with each MMP so that a user can have the opportunity to answer query after query to increase his or her “score” for each MMP advertising campaign. The user interface or frame 10 can also include a score field 18 that can maintain, for example, a running count of the number of questions answered correctly by the user.

The user interface or frame 10 can also include a user interface 26 that can include, for example, drop-down menus that allow a player to select which MMPs he or she wishes to view, data relating to his or her past performance, and the like. Advertising panels or banners 20, 22 can also be provided that display pop-up ads and the like alongside the MMP display area. For example, advertisers may wish to place ads relating to current specials or pricing on the product being showcased in the MMP. Thus, the advertising panels or banners can include material that is related to the MMP content being displayed. Alternately, the banners can include material that is only marginally related to the MMP content, or not related at all.

In one aspect of the invention, a player or user can begin a new “round” of the game by triggering a new MMP to be viewed/displayed. As the MMP is presented to the user, queries or “hotspots” will appear at pre-designated elapsed time periods, and the user can be prompted to input data accordingly. The queries or hotspots can be overlaid on the MMP, and, in one embodiment, the MMP is allowed to run without any disruption (e.g., it is not paused or stopped to allow the user to answer). In this manner, the user is pressured to answer quickly, so that he or she can continue to watch the MMP to acquire information necessary to answer the next query.

In this manner, the present invention provides an interface that encourages the user to pay very close attention to the MMP being presented. This aspect of the invention is very important to advertisers, as they can be more confident that the user/viewer is acquiring the information being presented than they might otherwise be with conventional systems.

The present system accomplishes this with a variety of features. By overlaying the various queries/prompts atop the MMP being played without disrupting the flow of the MMP, a user must give his or her full attention to the MMP in order to not miss information necessary to answer future queries/prompts. Also, as each query presented must be answered within a limited timeframe, the user is pressured to answer questions quickly (or respond quickly to prompts relating to hotspots and the like). In addition, a user's score can be based partly upon how quickly he or she answers each question/prompt. Also, if each question/prompt is answered correctly and quickly, the user will be presented with a higher number of questions/prompts during each particular MMP, affording them the opportunity to earn an even higher score.

Generally, questions or prompts can be strategically inserted at specific elapsed time intervals within an MMP; i.e. at five or ten second intervals, or whichever intervals are felt to provide the optimal engagement with a player. The intervals can be selected by the advertiser in consultation with the providers of the gaming interface. The queries or questions will typically pertain to the MMP being watched, the product being advertised, and/or trivia surrounding the product or service being advertised (and/or the provider of the product or service). The present invention can thus, through a combination of question content and timing, compel a user/player to dedicate more attention to details of the MMP clip than he or she would otherwise likely do.

To encourage the replay of particular commercials, each MMP can have a plurality of queries or prompts (hotspots, for example) associated with it that can randomly appear at different time thresholds (although each will likely be associated with a specific time threshold). In this manner, it may take several “play throughs” of a particular advertisement in order for a player to have an opportunity to answer each query. In one aspect of the invention, multiple queries/prompts can be prepared and can be associated with the same elapsed time. In other words, an MMP may have 4-5 queries associated with an elapsed time of ten seconds: in the event a user re-plays the MMP, he or she can be presented with a different query/prompt at the ten second interval than was presented to him or her the first time.

In one aspect, a “round” of the game can end when the MMP that is the subject of that round reaches its natural, predesigned end. At the end of a round, a player's score can be tabulated and displayed to the player, along with rewards that the user may have earned. Types of rewards include, without limitation, virtual rewards (e.g., placement on a high-score list, achievement points, in-game badges, etc.) and “real world” rewards (e.g., coupons that can be redeemed for real life discounts on products, and potentially points that can be redeemed as part of various promotions and giveaways).

Most queries/prompts presented during a round will test the player somehow and have a correct answer that contributes to a player's score. Also, “bonus” questions can also be asked either during a round or immediately at the end of one that have no right or wrong answer, but rather collect the player's opinion of a product or advertisement or encourage the player to otherwise provide information interesting to the various advertisers.

The present invention can allow for the pace of the experience to be varied. For example, a relatively quick pace can be established that presents queries to the user at less than five second intervals. A slower pace can be established by presenting queries at a pace of no less than ten seconds or more between queries. The pace of questions asked can be determined by the advertiser upon consultation prior to the campaign release and adjusted throughout the lifecycle of the campaign as the advertiser deems necessary.

The present invention can also be extended to provide “meta-game” features that extend beyond any particular product or advertising company. These features can encourage users to view many more randomly selected commercials than he or she might otherwise desire to watch. For example, forums and chat rooms can be offered to facilitate the creation of a community of users. High score lists, player profiles, and/or an achievement/badge system can be generated to provide players with goals and tools to compare their game results with the game results of others. An interface for user ratings of MMPs can also be provided, as well as an avenue for users to recommend particular commercials/MMPs to other players.

The system can also include modules that allow each player to be tracked (anonymously, if desired or necessary) as they play the game. These statistics can be used to provide advertisers with analytics information such as (a) how often a particular ad has been played; (b) how often players were able to answer or respond correctly to the various questions/prompts associated with a particular ad; (c) how much elapsed time players required to input correct or incorrect answers; (d) how highly players rate a particular ad; (e) how often players recommend a particular ad; (f) how often players replayed the same ad more than once; (g) how often players quit playing during an instance of an ad; (h) at what point during an ad players quit playing, if they quit playing; (i) when such information is available, how often players redeemed their rewards for playing a particular ad.

All such information can be stored and associated with demographic information related to the player that was gathered independently of any particular MMP (for example, demographic information relating to specific players can be captured during account creation). In this manner, advertisers can analyze the various statistics as they relate to demographic category (gender, age, income level, etc).

In those cases where a particular display presents technological limitations (e.g., cells phones, PDAs, etc.), the screen is typically much smaller, so players can either view menu screens, account screens, or a full-screen MMP with questions overlaid thereon (e.g., a separate UI need not be presented). In other words, when a player is interacting with an MMP, the system can limit or restrict peripheral advertisements or player statistics, except for those that can be displayed on top of the full screen MMP that is playing.

The system can be readily incorporated into various social networking interfaces, such as Facebook.com, Myspace.com, etc.

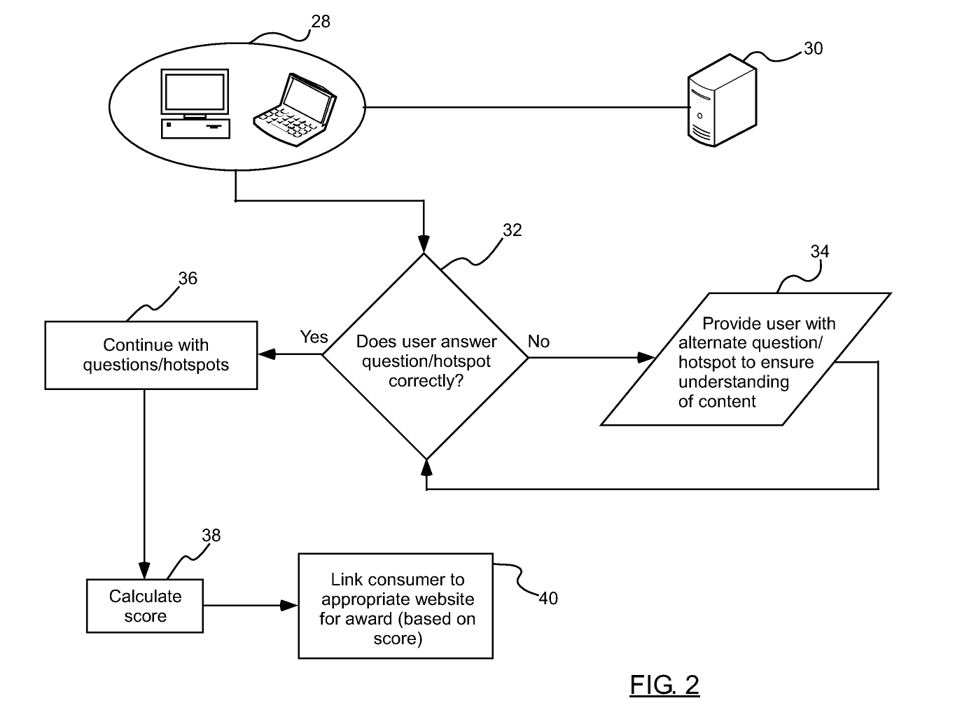

Turning now to FIGS. 2-4, various aspects of the invention are illustrated via flowcharts. In FIG. 2, an exemplary layout is provided by which the present invention can be carried out. Shown at 30 is a server on which various MMPs, hotspot overlays, MMP conversion processes and the like can be housed. At 28, a user can utilize a variety of devices (e.g., desktop computer, laptop, cell phones, PDAs, kiosks, etc.) to be presented with the MMP and the question/prompt overlays. In one embodiment, as shown at 32, if the user does not correctly answer a question/prompt, he or she can be presented with an alternate question/prompt (34) that relates to the same subject matter to ensure that the user understands the particular information the MMP is presenting. Once a query/prompt is answered correctly, further queries/prompts can be provided while the system (either locally, at the client level (PC, laptop, etc.), or remotely, at the server level) tracks the user's performance.

This process of presenting queries/prompts/hotspots can be continued multiple times throughout the predesigned progression of the MMP. This process can include several variations. For example, the user can first be presented with an initiation step, where the user triggers playback or playback is triggered automatically by the completion of the loading step. After initiation, the MMP can progress (e.g., play), and every second that elapses thereafter, the client application can check for new questions or prompts available for display.

In one aspect, questions or prompts can be available for display if: i) enough time has elapsed to present them; ii) they haven't already been correctly answered; and iii) the client player isn't already displaying some other question for which it is still waiting on an answer. If more than one query or prompt meets this criteria, then a query or prompt can be selected based on which has the highest display time.

For example, if a question predetermined to be displayed at five seconds of elapsed time is answered after fifteen seconds, then the system is cleared to present a new question or prompt (assuming the MMP continues to play after fifteen seconds). If there are two available questions or prompts for this timeframe (say, one scheduled at seven seconds and one scheduled at ten seconds), the ten second question can be displayed, as it is more timely. In other words, the system can adapt to the performance of the user to provide the most intuitive presentation to the user. In the example just provide, if the ten second question is answered correctly very quickly by the user, the seven second question can be presented immediately afterward. In one example, if more than one question or prompt meets the criteria, and more than one of those questions or prompts has the same display time, the final selection between these questions or prompts can be made randomly.

At 38, the user's performance can be evaluated and assigned a score or ranking. Depending upon the user's performance, the user can be routed, at 40, to a particular website to either claim his or her reward, or get more information on doing so. In some embodiments, the website to which the user is routed depends upon the user's performance. For example, a low-scoring user may be routed to a site that provides low-level rewards, such as discount offerings, etc. A high-scoring user might be routed to a website that delivers more desirable rewards, such as gift cards, free products, etc. Thus, the user is typically incentivized to obtain the highest score possible.

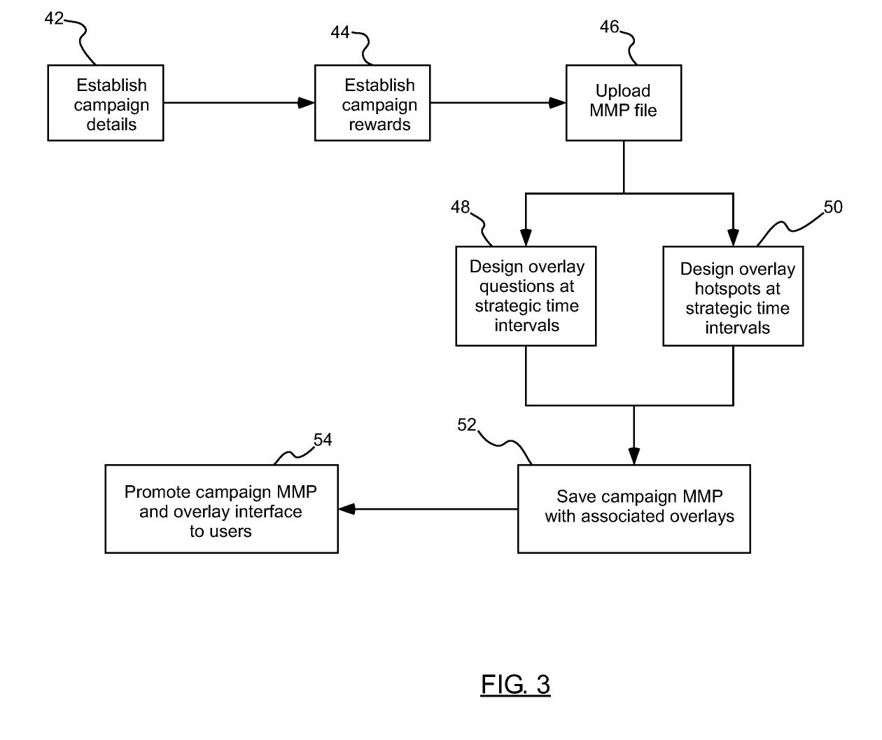

FIG. 3 illustrates one exemplary manner in which the present invention can create a campaign from an existing MMP. At 42, various campaign details can be established (often in collaboration with the retailer of the goods and/or services being promoted). Such details can include, without limitation, broad categories in which the MMP falls (e.g., auto sales, travel information, etc.), dates on which the retailer wishes the campaign to be run, channels of distribution of the campaign (e.g., web, smart phone, social network, email, etc.), and the like. At 46 the MMP file can be uploaded, and the overlays in the form of questions (48) and/or hotspots (50) and the like can be associated with the MMP. At 52, the MMP and the associated overlays are saved, after which they can be promoted and distributed to consumers.

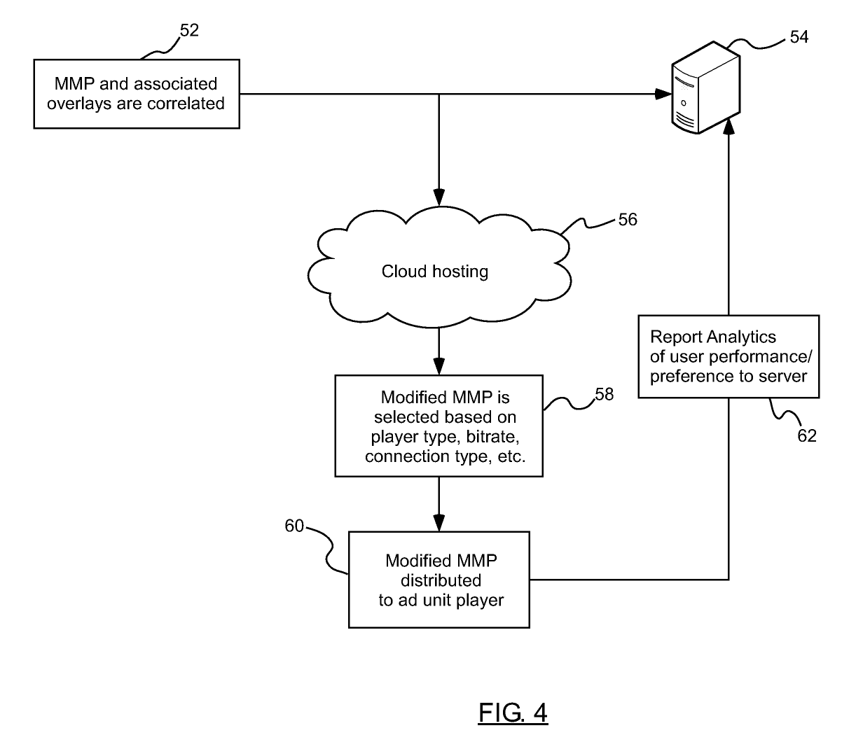

FIG. 4 illustrates further how the MMP and associated overlays can be distributed. The MMP source file and associated overlays can be housed on server 54 and can be distributed via a number of known methods. Examples include video cloud hosting and the like. The version of the MMP and associated overlays will depend upon the ad unit player that is being targeted. Exemplary ad unit players are often limited by the bandwidth available to deliver content to such units (and the size of the video screen of such units). For example, smart phones will often not have bandwidth available to them that is as large as bandwidth available to PC users. Thus, at 58, the version of the MMP that is desired can be selected, and delivered to the ad unit player at 60. At 62, the analytics of users' performance (and/or preferences, choices, etc.) can be reported to the server 54. The system can utilize the analytics to report to ad creators (or business owners) the various analytical details described above.

While execution of the various processes of the invention can vary, in one embodiment, the overlay information can be stored within a data packet, formatted in XML, JSON, AMF3, or raw binary formats understood by server and client player. The overlay data packet can contain substantially everything necessary to run the ad unit, for example, the overlay information, timing and scoring details, and URLs referring to the location of the MMP file(s) and companion banner images if applicable. In one aspect, the formatted description of the ad unit is sent first, and that description contains information that points to the location of the creative assets.

The user interface (e.g., the display frame 10 of FIG. 1) can be a web tool that communicates with the server in much the same way as the client applications do, by conversing via XML, JSON, or AMF3 data exchange.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

We claim:

1. An interactive advertisement multimedia platform, comprising:
a multimedia packet (“MMP”) containing or presenting information relating to goods or services, the MMP having a predesigned progression from beginning to end;
a display frame within which the MMP can be displayed, the display frame being displayable on a display screen;
a series of queries, each relating to content of the MMP, the series of queries being presentable in the display frame at predetermined elapsed time intervals while the MMP is being displayed without disrupting the predesigned progression of the MMP; and
a data input field oriented within the display frame, the data input field allowing a user to present answers to the queries.

2. The platform of claim 1, further comprising a display screen on which the display frame can be displayed.

3. The platform of claim 2, wherein the data input field is actively associated with the display screen.

4. The platform of claim 1, further comprising a data processing system, operable to evaluate the correctness of the user's answers and tabulate a score based on the user's aggregate responses.

5. The platform of claim 1, wherein the series of queries are each presented in the display frame for a limited time, to thereby limit a time in which the user can present answers to the queries.

6. The platform of claim 1, further comprising a time display, oriented in the display frame, the time display incrementing from a time at which a query is presented in the display frame.

7. The platform of claim 1, further comprising a series of hotspots presentable in the display frame at predetermined elapsed time intervals while the MMP is being displayed and without disrupting the predesigned progression of the MMP; and
a data input by which a user can engage one or more of the hotspots.

8. A method of providing an entertaining and interactive interface for a user to view a displayable multimedia packet, comprising:
obtaining a multimedia packet (“MMP”) relating to a product, service or provider, the MMP having a predesigned progression from beginning to end;
obtaining or generating a series of queries relating to the product, service or provider;
establishing a series of predetermined elapsed times, based on the MMP's predesigned progression, at which each of the various queries will be presented to the user;
associating each of the various queries with one of the predetermined elapsed times; and
placing the MMP and the queries into a format presentable to a user to allow the user to view the MMP along with the queries.

9. The method of claim 8, further comprising presenting the MMP and the queries to the user.

10. The method of claim 9, further comprising collecting data relating to an accuracy with which the user responds to the queries.

11. The method of claim 8, wherein the predetermined elapsed times are earlier than the end of the predesigned progression of the MMP.

12. The method of claim 8, wherein associating each of the various queries with one of the predetermined elapsed times includes associating queries at distinct, differing elapsed times during the predesigned progression of the MMP.

13. The method of claim 8, wherein the MMP comprises an audio/video clip predesigned for use as a multimedia commercial.

14. The method of claim 8, wherein the queries are established after creation of the MMP.

15. A method of providing an entertaining and interactive interface for a user to experience a displayable multimedia packet, comprising:
obtaining a multimedia packet (“MMP”) relating to a product, service or provider, the MMP having a predesigned progression;
obtaining or generating a series of queries relating to the product, service or provider;
establishing a series of predetermined elapsed times, based on the MMP's predesigned progression, at which each of the various queries will be presented to the user;
associating each of the various queries with one of the predetermined elapsed times;
displaying the MMP to the user; and
concurrently displaying to the user, without disrupting the predesigned progression of the MMP, one or more of the queries at the predetermined elapsed time.

16. The method of claim 15, further comprising collecting data relating to an accuracy with which the user responds to the queries.

17. The method of claim 15, further comprising collecting data relating to analytics of the presentation to the user and compiling the data into a report deliverable to an entity associated with the MMP.

18. The method of claim 15, wherein the MMP comprises an audio/video clip predesigned for use as a multimedia commercial.

19. The method of claim 18, wherein the queries are established after creation of the MMP.
